(19) United States
(12) Patent Application Publication
(10) Pub. No.: US 2005/0198754 A1
(43) Pub. Date: Sep. 15, 2005

(54) Powered toothbrush having a decorative sleeve

(75) Inventor: Tau Dai, Edison, NJ (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 11/112,895

(22) Filed: Apr. 22, 2005

Related U.S. Application Data
(63) Continuation of application No. PCT/US03/34013, filed on Oct. 24, 2003.
(60) Provisional application No. 60/421,925, filed on Oct. 29, 2002.

(51) Int. Cl. A61C 17/22

(52) U.S. Cl. 15/22.1; 15/246

(57) ABSTRACT

The present invention relates to a powered toothbrush containing a decorative sleeve, which sleeve may be permanently attached to the toothbrush handle or may be replaceable by the user.

### CROSS-REFERENCE TO RELATED APPLICATIONS

This is a continuation of International Application PCT/US03/34013, filed Oct. 24, 2003, which claims priority from U.S. application 60/421,925, filed Oct. 29, 2002, both of which are incorporated by reference herein in their entirety.

### FIELD OF THE INVENTION

The present invention relates generally to toothbrushes, and, more particularly, to an economical powered toothbrush assembly having a standardized handle capable of receiving and retaining alternative decorative sleeves.

### DESCRIPTION OF THE RELATED ART

Various types of non-powered toothbrushes having object-shaped handles are generally known in the art, and are designed to provide ergonomic grips, aesthetically pleasing appearances and/or appeal to children to encourage them to brush their teeth for enhanced oral health. Examples of such toothbrushes that appeal to children include U.S. Design Patent Nos. 237659, 443765, 452381, and 452382, which disclose toothbrushes having handles shaped like vehicles (e.g., race cars, rocket ships, jets, etc.). U.S. Design Patent Nos. 329948, 347146, 347147, 347148, 363166, 402119, 434907, and 452380, and U.S. Pat. Nos. 5,353,464 and 6,026,532 disclose toothbrushes having handles shaped like animals. Other toothbrush designs containing human or toy shapes which appeal to children are disclosed in U.S. Design Patent Nos. 113744, 155668, 175198, and 209574.

Many powered toothbrushes include handles formed by connecting two body portions or shells to form a complete housing. Examples of such powered toothbrushes may be found in U.S. Pat. Nos. 5,115,530, 5,341,534, 6,148,462, and 6,202,242. U.S. Pat. No. 6,202,242 discloses a light-emitting, electric toothbrush that includes a handle made from a front body portion and a rear body portion. The front and rear body portions are ultrasonically bonded together along an interface line, to permanently seal the two body portions. The toothbrush handle of U.S. Pat. No. 6,202,242 does not have a decorative sleeve. None of the aforementioned toothbrushes discloses joining a decorative sleeve about the exterior of a standardized powered discloses joining a decorative sleeve about the exterior of a standardized powered toothbrush handle.

U.S. Pat. No. 5,590,436 discloses a non-powered toothbrush having a handle that carries a figurine formed separately from but attached to the handle. The figurine can be attached directly to the handle of the toothbrush or can be attached first to a carrier which is then attached to the handle. The toothbrush handle of U.S. Pat. No. 5,590,436 does not disclose use of a decorative sleeve about the exterior of an otherwise complete toothbrush handle.

Various techniques have been suggested for modifying the handle of a toothbrush to facilitate better manipulation of the brush during use. For instance, U.S. Pat. No. 2,179,266 describes a grip attachment in the form of a tubular sleeve containing opposed bearing portions for engaging the thumb and index finger of the user's hand. In one embodiment, the attachment is fabricated from a rubber-like material that allows the tubular sleeve to be stretched over the toothbrush handle and frictionally engage the underlying surfaces of the handle. U.S. Pat. No. 4,283,808 also describes a detachable gripping device for a toothbrush. The device consists of an elongated plastic foam body having a diameter that can be readily gripped by the user of the toothbrush. The plastic body also includes a centrally disposed longitudinal slot adapted to receive and engage the toothbrush handle. The toothbrush handle attachments of these patents are for gripping rather than decorative purposes.

Thus, there is a need in the art to provide powered toothbrushes having a decorative sleeve for economic, ergonomic, and/or aesthetic reasons, especially sleeves designed to appeal to children to encourage them to brush their teeth.

### SUMMARY OF THE INVENTION

The present invention solves the problems of the related art by providing a powered toothbrush having a standardized handle to provide manufacturing efficiency and economy, to which standardized handle alternate decorative sleeves may be permanently or removable and replaceably connected. The decorative sleeve may have designs that appeal to children, to motivate them to brush their teeth often and to set in place lifelong habits of good oral hygiene.

Alternatively, the decorative sleeve may be used as a location for advertising material. The powered toothbrush may then be sold to a variety of manufactures, who in turn, may place their own unique identification or advertising material on the decorative sleeve. Such manufacturers may then offer the powered toothbrushes, with their unique sleeve, as promotional items for their companies and/or their products.

As embodied and broadly described herein, the present invention is broadly drawn to a powered toothbrush assembly, comprising: a head connected to a neck, said head having a plurality of bristles extending outwardly therefrom; a handle connected to said neck; and a decorative sleeve connected to said handle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded, front elevational view of a powered toothbrush and unattached decorative sleeve in accordance with an embodiment of the present invention;

FIG. 2 is a fragmental rear elevational view of the powered toothbrush shown in FIG. 1, with the decorative sleeve attached;

FIG. 3 is a fragmental, cross-sectional view showing the decorative sleeve attached to a base of the powered toothbrush handle shown in FIGS. 1 and 2 by a screw; and

FIG. 4 is a fragmental, elevational view of the powered toothbrush handle shown in FIGS. 1-3, and a heat-shrinkable decorative sleeve in accordance with another embodiment of the present invention.

### DETAILED DESCRIPTION OF EMBODIMENTS OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

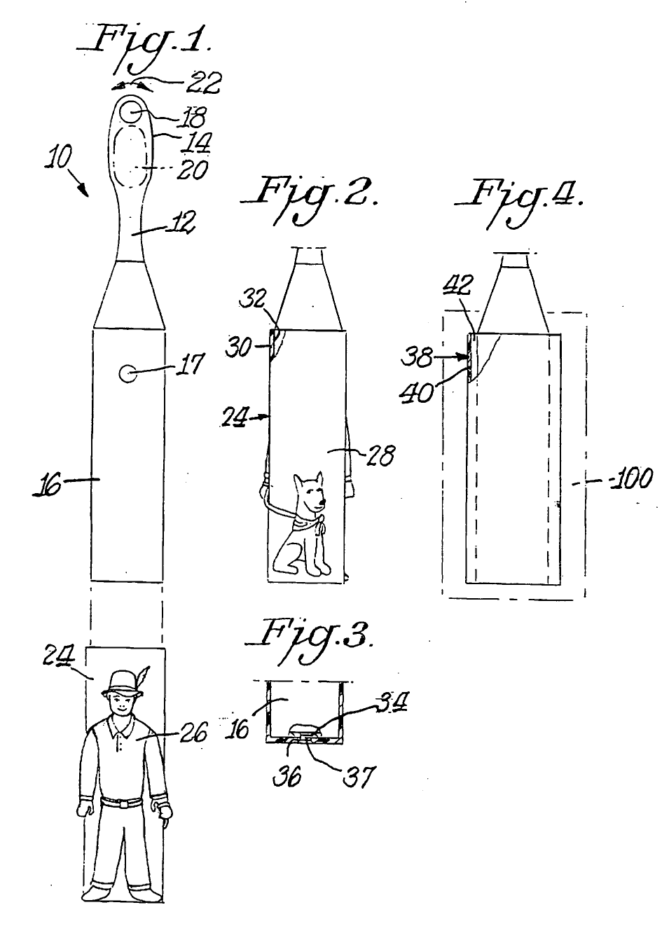

FIGS. 1 and 2 illustrate one practice of the present invention wherein a powered toothbrush 10 includes a neck section 12 interposed between a head 14 and a handheld handle 16. Preferably, neck 12 and head 14 are integrally connected, and together are detachably connected to handle 16 so that head 14 may be replaced as the bristles become worn. In an alternate, less costly embodiment of the present invention, the head 14 and neck 12 are integral and permanently connected to the handle 16. Head 14 may contain a movable bristle bearing platform 18 or a tuft block 20 in variety of shapes, including but not limited to circular, oval, square, rectangular, various regular or irregular shapes, etc.

As illustrated, particularly in FIG. 1, head 14 includes a first tuft block 18, which is illustrated as being at the outermost or distal portion of head 14. First tuft block 18 is preferably a disk of circular ring-type shape, and is movably driven in a rotating or oscillating manner as indicated by arrow 22 in FIG. 1. Other shapes may be used for first tuft block 18, such as oval or various regular of irregular shapes. First tuft block 18 may be provided with a multitude of tufts or bristles, arranged in a circular manner. The bristles may extend away from an outer surface of head 14.

First tuft block 18 may be oscillated by any suitable drive mechanism. For example, the drive mechanism described in U.S. Pat. No. 5,625,916, the disclosure of which being incorporated by reference herein in its entirety except where inconsistent with the express teachings of the present invention, may be used to oscillate first tuft block 18.

A second tuft block 20 may be fixedly attached to head 14 at a location above neck 12, but below first tuft block 18. Second tuft block 20 may include a multitude of tufts or bristles extending away from the outer surface of head 14. It is to be understood, however, that second tuft block 20 could be located distally from, or laterally side-by-side to first tuft block 18. It is preferred, however, that second tuft block 20 be longitudinally outside of first tuft block 18 so as to extend the length of the surface area of head 14 having bristles.

The provision of second tuft block 20 in this manner is advantageous in that powered toothbrush 10 simulates, in appearance of head 14, the structure of a manual toothbrush. This makes powered toothbrush 10 more acceptable to users since the appearance simulates what a user is accustomed to seeing. In addition, two tuft blocks 18, 20 even further enhance the efficiency of toothbrush 10, both as a result of the movement of tuft blocks 18, 20, and of the ability to readily retain toothpaste.

While conventional fiber form bristles are preferred, the term “bristles” as used herein is intended to be used in a generic sense as cleaning elements or massage elements and could include, for example, elastomeric fingers or walls arranged in a circular cross-section shape or any type of desired shape, including straight portions or sinusoidal portions.

The bristles could be mounted to the tuft blocks or sections by extending through suitable openings in the outer surface of head 14 so that the base of the bristles is mounted within or below the outer surface of head 14 using conventional staple or in-mold tufting technology for mounting therein. If desired, the bristles could be embedded in an elastomeric material which would permit the bristles to have an independent motion. Such various forms of bristles may thus be used for the bristles used in any section of head 14.

It is to be understood that the specific type of bristles may vary. The invention can be practiced with various combinations of the same or different bristle configurations as disclosed in U.S. Pat. Nos. 5,609,890, 5,390,984, and 5,533,791, the disclosures of which being incorporated by reference herein in their entirety, and/or with the same or different bristle materials, such as nylon bristles, spiral bristles, rubber bristles, etc. Similarly, while the bristles may be generally perpendicular to outer surface of head 14, some or all of the bristles may be angled at various angles with respect to the outer surface of the bristle head. It is thereby possible to select the combination of bristle configurations, bristle materials and bristle orientations to achieve specific intended results, such as to create as much movement from the oscillating tuft heads to deliver additional oral health benefits like enhanced cleaning, tooth polishing, tooth whitening and/or massaging of the gums.

As further shown in FIGS. 1 and 2, a decorative sleeve 24 may be provided, each molded of known plastics, including for example a copolymer such as ABS (acrylonitrile, butadiene, styrene copolymer) or a high impact styrene. Decorative sleeve 24 may also be fabricated from a material which is compressible, so that sleeve 24 may be force fit or heat shrunk around handle 16. Thus, sleeve 24 may also be fabricated from an elastomeric material, such as neoprene, urethane, silicone rubber, RTV rubber, or a thermoplastic injection moldable rubber such as Santoprene® rubber available from Monsanto Chemical Company.

The decorative sleeve 24 can be removeably or permanently connected to the outer surface of handle 16, by means discussed below. Sleeve 24 may or may not be decorative in three-hundred and sixty degrees, i.e., being decorative on a front portion 26 and a rear portion 28. Sleeve 24 may or may not contain a three-dimensional design, on the front portion 26, rear portion 28, or both.

Handle 16 can be pre-formed as a single, generally hollow shell or as two or more separate shell portions which are joined together by welding or other known means. Pre-forming handles 16 or pre-forming complete powered toothbrushes 10 to accept alternative decorated sleeves 24 provides for an efficient, less costly manufacturing process, in that the pre-formed handles 16 or complete powered toothbrushes 10 can be manufactured in longer manufacturing runs which have less wastage and less set-up labor costs than short manufacturing runs in which a decorative handle is altered.

Decorative sleeve 24 preferably includes a body portion 30 having an opening 32 provided therein. In the embodiment of decorative sleeve 24 shown in FIGS. 1 and 2, opening 32 is geometrically sized and shaped to conform to the size and shape of handle 16. This way decorative sleeve 24 may be press or force fit onto handle 16, and may further be removeably detached from handle 16 to provide for interchangeable decorative sleeves 24. This interconnection enables decorative sleeve 24 to be mechanically and removeably attached and detached to handle 16. Alternatively, decorative sleeve 24 may be permanently attached to handle 16 in a variety of ways. For example, decorative sleeve 24 may be ultrasonically or adhesively, using cold or hot adhesives, bonded to handle. Decorative sleeve 24 may also be connected to handle 16 with a mechanical connector (nuts and bolts, screws, etc.) as discussed below, heat or laser welded, etc.

In an alternative embodiment of decorative sleeve 24, as shown in FIG. 3, body portion 30 of sleeve 24 may have a tapped hole 34 and a recess 36 arranged in body portion 30 to receive a beveled head screw 37 that interconnects with a lower portion of handle in a known manner. This way decorative sleeve 24 may be removeably attached to and detached from handle 16 to provide for interchangeable decorative sleeves 24. Other types of mechanical fasteners, other than screw 37, may be utilized with the embodiment shown in FIG. 3, such as for example, nuts and bolts, rivets, heat or laser welded, etc. Since decorative sleeve 24 shown in FIG. 3 is attached with a mechanical fastener, body portion 30 of sleeve 24 need not be sized and shaped to conform to the size and shape of handle 16.

An alternative type of decorative sleeve 38 is provided in FIG. 4 in the form of a heat-shrinkable sleeve. Decorative sleeve 38 includes a body portion 40 with an opening 42 provided therein that is slightly larger in shape but conforms to the shape of handle 16. When heat is applied to decorative sleeve 38 by a heat source (e.g., an electric oven 100), sleeve 38 will shrink to conform and adhere to the outer surface of handle 16 for permanent attachment thereto.

Handle 16 may have an opening provided at an end portion thereof located away from neck 12. The hollow nature of handle 16 enables handle 16 to enclose the drive mechanism (not shown) for oscillating first tuft block 18 as well as the mechanism(s) providing power to the drive mechanism. The opening of handle 16 may be enclosed by an end cap or base. The end cap or base enables a power mechanism, batteries for example, to be inserted in or removed and replaced from handle 16. The end cap or base may connect to handle 16 via a variety of connection mechanism which may include a force fit male/female interlock or a hinged screwed door which allows access to pry-off the end cap or base.

Handle 16 is also provided with a button 17 for controlling the drive mechanism of the powered toothbrush 10. Button 17 may extend through an opening provided in decorative sleeve 24, 38 or may be seated behind body portion 30 of sleeve 24, 38. Button 17 may control the drive mechanism, and thus the oscillation of first tuft block 18, in a known on-off type manner. Although one button 17 is shown in FIG. 1, button 17 may be replaced with a single switch or other control mechanism for the drive mechanism (e.g., two buttons, one to energize the drive mechanism and one to de-energize the drive mechanism). Button 17 may connect to a switch that controls the energizing of the drive mechanism.

The decorative sleeves 24, 38 may have a three-dimensional design, such as the man and dog illustrated in FIG. 1, or alternatively a vehicle, or a soldier, or a fireman, or a policeman, or other image that appeals to children and that can be used by a child in play as a toy. A powered toothbrush 10 having a handle 16 with such a toy-shaped, decorative sleeve 24, 38 provided therein offers a fun and exciting way for children to brush their teeth. Such excitement motivates children to brush their teeth often, to set in place lifelong habits of good oral hygiene.

Alternatively, the decorative sleeves 24, 38 may be used as a location for advertising material. The powered toothbrush 10 may then be sold to a variety of manufactures, who in turn, may place their own unique advertising material on the decorative sleeves 24, 38. Such manufacturers may then offer the powered toothbrushes 10, with their unique sleeves 24, 38, as promotional items for their companies and/or their products.

1. A powered toothbrush assembly, comprising:
a head connected to a neck, said head having a plurality of bristles extending outwardly therefrom;
a handle connected to said neck; and
a decorative sleeve connected to said handle;
wherein said decorative sleeve contains a three-dimensional design.

2. A powered toothbrush assembly as recited in claim 1, wherein said decorative sleeve conforms to the shape of said handle and is retained on an outer surface thereof.

3. A powered toothbrush assembly as recited in claim 2, wherein said decorative sleeve comprises a body portion that is arcuate in shape and conforms to an arcuate shape of said handle.

4. A powered toothbrush assembly as recited in claim 2, wherein said decorative sleeve is mechanically force fit onto the outer surface of said handle.

5. A powered toothbrush assembly as recited in claim 4, wherein said decorative sleeve is one of ultrasonically or adhesively bonded to said handle.

6. A powered toothbrush assembly as recited in claim 2, wherein said decorative sleeve is coupled with a mechanical connector to said handle.

7. A powered toothbrush assembly as recited in claim 2, wherein said decorative sleeve is heated to shrink and adhere to the outer surface of said handle.

8. A powered toothbrush assembly as recited in claim 1, wherein a design is provided on both a front and a rear portion of said decorative sleeve.

9. A powered toothbrush assembly as recited in claim 1, wherein said decorative sleeve is permanently connected to said handle.

10. A powered toothbrush assembly as recited in claim 1, wherein said decorative sleeve is removeably connected to said handle.

11. A powered toothbrush assembly as recited in claim 1, wherein said handle includes a drive mechanism and wherein the plurality of bristles comprises at least one movable tuft block that is driven by said drive mechanism.

12. A powered toothbrush assembly as recited in claim 11, wherein the plurality of bristles further comprises at least a second movable tuft block.

13. A powered toothbrush assembly as recited in claim 11, wherein the plurality of bristles further comprises at least one non-movable tuft block.

14. A powered toothbrush assembly as recited in claim 11, wherein the at least one movable tuft block is rotatably movable.

15. A powered toothbrush assembly as recited in claim 11, wherein the at least one movable tuft block oscillates.

16. A powered toothbrush assembly as recited in claim 15, wherein the at least one movable tuft block has a circular shape.

17. A powered toothbrush assembly as recited in claim 16, wherein the handle further comprises a switch for controlling the drive mechanism.

18. A powered toothbrush assembly as recited in claim 17, wherein the switch further comprises a separate control for energizing and de-energizing the drive mechanism.

19. A powered toothbrush assembly as recited in claim 17, wherein the head simulates the structure of a manual toothbrush.

20. A powered toothbrush assembly as recited in claim 1, wherein the plurality of bristles includes an elastomeric element.
